(19) United States
(12) Patent Application Publication
(10) Pub. No.: US 2015/0338715 A1
(43) Pub. Date: Nov. 26, 2015

(54) TRANSPARENT DISPLAY DEVICE

(71) Applicants: Eike Schaefer, Anger (DE); Rainer Vogt, Bad Reichenhall (DE); Michael Brankl, Maria Taferl (AT); Michael Zeiner, Altomünster (DE); Matthias Keller, Geisingen (DE); Werner Schubert, Deisenhofen (DE); Stefan Warmuth, Mittelstetten (DE); Thomas Kloiber, München (DE); Doris Blume, Eisenach (DE); Jan Herrmann, Suhl (DE)

(72) Inventors: Eike Schaefer, Anger (DE); Rainer Vogt, Bad Reichenhall (DE); Michael Brankl, Maria Taferl (AT); Michael Zeiner, Altomünster (DE); Matthias Keller, Geisingen (DE); Werner Schubert, Deisenhofen (DE); Stefan Warmuth, Mittelstetten (DE); Thomas Kloiber, München (DE); Doris Blume, Eisenach (DE); Jan Herrmann, Suhl (DE)

(73) Assignee: Red Bull GmbH, Fuschl am See (AT)

(21) Appl. No.: 14/414,080

(22) PCT Filed: Jul. 9, 2012
(86) PCT No.: PCT/EP2012/002896

§ 371 Date: Aug. 3, 2015

(51) Int. Cl. G02F 1/163; A47F 3/04; F21V 33/00; F25D 1/00

(52) U.S. Cl. CPC G02F 1/163; F25D 1/00; A47F 3/0434; F21V 33/00

(57) ABSTRACT

A display device (1, 1′, 1″, 1″′, 1^{IV}, 1^{V}) comprises at least one transparent or translucent display layer (5, 5′, 5″), and at least one modifiable layer comprised of a film or foil layer, configured and adapted to have a degree of transparency modified depending on an input signal applied thereto and placed at least partly in front and/or behind said display layer. A door or cover plate (17, 17′, 17″) may comprise a display device (1, 1′, 1″, 1″′, 1^{IV}, 1^{V}) as disclosed herein. Furthermore, a cooler (21, 21′) may comprise a display device (1, 1′, 1″, 1″′, 1^{IV}, 1^{V}) and/or a door or cover plate (17, 17′, 17″) as disclosed herein.

The present invention relates to a display device, a door or cover plate comprising a display device according to the invention and a cooler comprising a door or cover plate and/or a display device according to the invention.

Transparent displays are known in the state of the art. For example, Thin-Film-Transistor-(TFT)-Displays can be made completely transparent by using transparent semiconductors and transparent electrodes, such as for example indium tin oxide (ITO).

US 2010/0309420 A1 discloses a liquid crystal display apparatus comprising a transparent pixel electrode formed on a transparent substrate of TFTs, which is connected to a drain electrode of TFTs.

One disadvantage of the known transparent displays is that the contrast of the known transparent displays is weak and depends of the background of the displays at the respective installation sides. In particular, if such transparent displays are used in front of objects of different shapes and colors, the contrast of the objects displayed on said transparent displays varies significantly. As a result, the best use of such transparent displays is in combination with monochrome backgrounds only.

Moreover, smart glass, or switchable glass, is known in the state of the art. Smart glass changes its light transmission properties when a voltage is applied. In general, if a voltage is applied to such a smart glass, the smart glass changes from opaque up to translucent.

In general, smart glass can comprise electrochromic devices, suspended particle devices, mirco-blinds, or liquid crystal devices. Examples of a smart glasses are disclosed in DE 198 28 630 A1 and DE 10 2011 015 949 A1. It is obvious for a person skilled in the art that also other types of realizations of smart glasses are possible.

It is known in the state of the art to use such a smart glass to provide privacy in conference rooms, etc. In addition to, other applications are known in the state of the art to use such a smart glass, e.g., if switched to opaque to provide a projection screen for beamers.

In addition to, it is known from JP 04052488 A to use such a smart glass within a door of a household appliance, in particular within a door of a refrigerator.

In the sense of the present invention, the term cooler should be representative for every cooling device, like a refrigerator, a cooling box, and the like.

In light of the state of the art known, it would be advantageously to be able to use such transparent displays independent of a background.

The object of the present invention is therefore to overcome the disadvantages of the state of the art and to provide a transparent display device that can be used independent of its background at an installation side.

Another objective of the present invention is to provide a transparent display device having, if desired, a high contrast and low transparency.

The object is archived by a display device comprising at least one, in particular transparent or translucent, display layer, and at least one modifiable layer, in particular a film an/or foil layer, configured and adapted to have its degree of transparency modified depending on an input signal applied thereto and placed at least partly in front and/or behind said display layer.

A layer in the sense of the present invention can also be a plate or the like. A modifiable layer can be in one embodiment a transparency modifiable layer. In the sense of the present invention, a transparency modification can e.g. mean that the transparency of the modifiable layer changes. Furthermore, a modifiable layer can be in one embodiment an electrochromic layer.

The inventive display device allows several different modes of operation. In a first mode of operation the display device itself is transparent and, in particular, looks like a normal window or transparent plate to an observer. In this mode of operation, the transparent display layer is inactive and the modifiable layer is switched to be, in particular fully, transparent. In a second mode of operation, the transparent display layer is activated, e.g. displays a picture, text, a movie or the like. Due to the transparency of the transparent display layer, the background behind the transparent display layer is visible. It is known in the state of the art that the transmittance of such a transparent display layer may be 20% having a contrast of 500:1 if activated.

In a third mode of operation, the film or foil layer may change its degree of transparency from transparent to opaque. It is obvious for a person skilled in the art that the modifiable layer can change continuously to any degree of transparency between transparent and opaque, for example being semi-transparent. It is also obvious for a person skilled in the art that the modifiable layer can be coloured in different colours, like white, black, green, blue, or the like, while being not transparent or semi-transparent. Preferably, the modifiable layer can change its degree of transparency from transparent to opaque by becoming a whiter tone until looking like a white plate for an observer. In a fourth mode of operation, the display layer is activated and the modifiable layer is switched to be opaque. It is preferred that the switching time from fully transparent to opaque and vice versa is not longer than 10 ms. In this mode of operation, the contrast of the transparent display layer is high. This is due to the fact that modifiable layer switched to opaque may provide a background for the transparent display layer.

Therefore, by using a combination of a transparent display layer and a modifiable layer according to the invention, it is possible to improve the contrast of the display elements if desired. As a result, the displaying of elements on transparent display units become independent of the backgrounds of installations sides of such display devices.

In another preferred embodiment of the invention the modifiable layer is configured and adapted to modify its degree of transparency depending on a voltage applied thereto, the modifying layer in particular being or comprising an electrochromic layer.

The voltage can be in one embodiment be representing or being part of the input signal.

In another preferred embodiment of the invention the modifiable layer is configured and adapted to switch reversibly between being transparent, semi-transparent, opaque and/or white, preferably depending on an input signal applied thereto.

It is preferred to control the degree of transparency of the modifiable layer by an input signal being applied. Depending of the input signal, preferably an input voltage, the degree of transparency of the modifiable layer can be changed easily.

According to a preferred embodiment the modifiable layer is configured and adapted to switch reversibly between being transparent, semi-transparent, opaque and/or white, preferably depending on an input signal applied. In one embodiment of the present invention the modifiable layer can be switched between being transparent and opaque. In a further embodiment of the present invention the modifiable layer can be switched between being transparent and white.

According to a preferred embodiment the modifiable layer comprises or consists of a layered system in which at least one layer comprises long-chain molecules, in particular polymer chains and/or molecules having a backbone and/or side chain,

Such a layered system of a modifiable layer has proven to be advantageously. In particular, a layered system comprising long-chain molecules, preferably polymer chains and/or molecules having a longer backbone and/or side chain shows excellent results to enable a modifiable layer to change its degree of transparency.

Moreover, in a further embodiment of the invention the modifiable layer is located adjacent to the display layer. Adjacent can in one embodiment of the invention be understood as being placed directly.

Moreover, in a further embodiment of the invention the modifiable layer is laminated at least on parts of a glass support and/or parts of the display layer.

It can be advantageous to locate the modifiable layer close to the transparent display layer to rise the contrast of the transparent display if the modifiable layer is switched to be semitransparent or opaque. Furthermore, it can be beneficial to laminate the modifiable layer onto a support, preferably a glass support. To minimize the distance between the transparent display layer and the modifiable layer it might be to the best advantage according to one embodiment of the present invention to limited the modifiable layer directly on the transparent display layer, in particular onto the glass support and/or other parts of the transparent display layer. Thereby, if the modifiable layer is switched to opaque, a maximal contrast can be archived.

Additionally, it can be advantageous that the second layer is arranged, at least partly, between the first and the third layer.

Furthermore, it can be advantageous that at least one modifiable layer comprises, in particular in this sequence, a first layer comprising or consisting of indium tin oxide, a second layer, in particular comprising or consisting of a transparency changing layer, comprising or consisting of a polymer and/or liquid crystals, and a third layer comprising or consisting of indium tin oxide,

Indium tin oxide provides a possibility to realize the transparent electrodes needed for the modifiable layer to be transparent. The second layer comprising or consisting of preferably a polymer and/or liquid crystals allows changing the degree of transparency of the modifiable layer in particular dependent of a voltage being applied to the indium tin oxide layers. Furthermore, with the help of these types of layers a fast switching between the different degrees of transparency can be provided. In addition to, such layers provides a high life time.

In another preferred embodiment of the invention the display layer comprises at least one transparent Thin-Film-Transistor-display unit and/or layer and/or at least one transparent Organic-Light-Emitting-Diode-display unit and/or layer.

A transparent Thin-Film-Transistor-display unit and/or layer and/or at least one transparent Organic-Light-Emitting-Diode-display unit and/or layer have been proven beneficial for use a transparent display layers.

Additionally, it can be advantageous that the display device comprises at least one protective layer and/or at least one insulating layer.

Additionally, it can be advantageous that the display device comprises at least one light emitting layer configured and adapted to emit light, wherein in particular the at least one light emitting layer comprises light emitting diodes, organic light emitting diodes and/or cold-cathode fluorescent lamps, in particular in form of stripes, preferably the light emitting layer being configured and adapted to be dimmable and/or transparent and/or the light emitting layer having a structure configured and adapted to diffuse light, in particular to diffuse light irradiated in at least one of the edges of the light emitting layer, preferably to emit light irradiated in at least one of the edges of the light emitting layer in direction to at least one of the other layers at least substantially.

Exemplarily it can be of advantage that the light emitting layer acts as an diffuser for light irradiated into the light emitting layer. Thereby, it can be possible to arrange a lighting unit at least at one side of the rim of the light emitting layer. In the alternative or in addition to it can be in one embodiment of the invention of advantage to integrate light emitting diodes on the surface and/or as integral parts of the light emitting layer, in particular transparent light emitting diodes.

By using a light emitting layer the contrast of the display layer can actively be changed. Furthermore, it can be possible to generate light effects onto the display device, preferably in addition to the content displayed onto the display layer. With the help of two of the layers of the display device spaced apart it is possible to use external light sources to generate light effects within the display device that are arranged at the next to the sides of the light emitting layer.

Additionally, it can be advantageous that the at least one light emitting layer and/or the display further comprising stripes, in particular stripes comprising light emitting diodes, organic light emitting diodes and/or cold-cathode fluorescent lamps, along the rim of the protective layer and/or the insulating layer preferably applied to the front and/or the back surface of the protective layer and/or the insulating layer.

In one embodiment of the present invention the light emitting layer can be arranged next to the corners and/or the rim of the display device only, e.g. in form of stripes or the like. Furthermore, it can be of advantage in one embodiment that the light emitting layer is arrange only at one, two and/or three sides of the display device, in particular in form of stripes, preferably next to the corners and/or the rim of the display device.

Moreover, in a further embodiment of the invention at least one modifiable layer and/or at least one light emitting layer is coated and/or evaporated onto a layer, in particular onto the display layer, the protective layer and/or the insulating layer.

It might be advantageous to coat and/or evaporate the at least one modifiable layer and/or at least one light emitting layer onto at least one other layers of the display device directly. In particular, it might be of advantage to arrange the at least one modifiable layer close to the display layer by coat and/or evaporate the at least one modifiable layer directly onto the display layer, the protective layer and/or the insulating layer, in particular to optimize the contrast of the display layer and/or to reduce the production costs.

Additionally, it can be advantageous that the display is, at least partly, arranged between at least a first protective layer and at least a second protective layer, between at least one protective layer and at least one insulating layer and/or between at least a first insulating layer and at least a second insulating layer.

This is in particular beneficial to protect the transparent display layer if the transparent display layer is protected at least on one of its sides by a protective layer. Furthermore, for the use of a display unit according to the invention in a door, cover plate or a window it can be useful to use an insolating layer to reduce the heat transfer from one side of the display unit to the other.

Moreover, in a further embodiment of the invention the protective layer and/or the insulating layer are, at least partly, transparent.

Moreover, in a further embodiment of the invention the protective layer and/or the isolating the protective layer and/or the insulating layer comprise or consists of glass.

According to the invention, the use of transparent materials for the protective and/or the insulating layer is useful allowing to provide a fully transparent display unit if desired.

According to a preferred embodiment the individual layers of the display device are arranged in the following sequence: a protective layer being the first layer, the display layer being the second layer, the modifiable layer being the third layer and an insulating layer or another protective layer being the fourth layer and in particular at least one light emitting layer being arranged between the first, second, third and/or fourth layer or the at least one light emitting layer being a fifth layer being arranged in front of the first layer or at the back of the fourth layer, wherein in particular at least two adjacent layers are contacting each other.

the individual layers of the display device are arranged in the following sequence: a protective layer being the first layer, the display layer being the second layer, the modifiable layer being the third layer and an insulating layer being the fourth layer and in particular at least one light emitting layer being arranged between the first, second, third and/or fourth layer or the at least one light emitting layer being a fifth layer being arranged in front of the first layer or at the back of the fourth layer, in particular at least two adjacent layers are contacting each other.

With the use of the at least one light emitting layer, additional light effects can be provided. Depending on the position of the at least one light emitting layer it is possible to weak or strength the contrast of the display layer.

According to another a preferred embodiment the individual layers of the display device are arranged in the following sequence: a protective layer being the first layer, the display layer being the second layer, an insulating layer or another protective layer being the third layer and/or the modifiable layer being the fourth layer, the light emitting layer being the fifth layer, an insulating layer, another protective layer and/or a modifiable layer being the sixth layer, in particular at least two adjacent layers are contacting each other.

This arrangement of the layers can be advantageous due to the fact that display layer is arranged closer to the insulating layer and therefore one the one hand the light emitting layer can be added in a production process depending on the customers' preferences. Furthermore, with the help of two insulating layers the isolation of the display device could be improved.

Additionally, it can be advantageous that the light emitting layer is arranged between a modifiable layer and a further modifiable layer.

This arrangement is in particular of advantage to protect a user from being blinded by the light emitting layer. If a user is at the back side of the display device, e.g. according to one of the possible arrangements of the layers behind the display layer and the modifiable layer as well as the light emitting layer, the light emitting layer can be too bright. With the help of a further modifiable layer it is possible to reduced the brightness of the light emitting layer while looking at the back side of the display device. This in particular of relevance if the display device is in use in a dark environment.

Moreover, in a further embodiment of the invention between the first, second, third and/or fourth layer at least one additional layer is arranged or no additional layer is arranged between the first, second, third and/or fourth layer.

This arrangement of the layers of a display unit according to the invention is advantageously due to the fact, that the transparent display layer is protected by the protective layer and, if desire, the contrast of the transparent display layer can be raised depending on the degree of transparency of the modifiable layer arranged behind the transparent display layer. With the help of the insulating layer, the heat transfer from one side to the other from the display unit can in addition be reduced significantly.

Moreover, in a further embodiment of the invention the modifiable layer comprises at least two areas, in particular n areas, whereby each of the at least two, preferably all of the, areas of the modifiable layer are configured and adapted to change its degree of transparency independently.

In light of the present invention n areas can be for example, 2,3,4,5,6,7,8,9,10,11,12,13,14,15, 16, 17, 18, 19, 20, or more areas.

By using such a modifiable layer separated into multiple areas that are configured and adapted to work independent of each other it is possible to configure the display device to work in different advantageous modes of operation. Thereby, it might be possible that at least one of the areas of the modifiable layer is switched to be transparent, while at least one of the other areas of the modifiable layer is switched to be opaque. It can be for example possible to raise the contrast of parts of the display device only by switching only certain areas of the modifiable layer to opaque. Thereby, e.g. it is possible show a user the background of the display device on certain areas of the display device by areas of the modifiable layer being transparent, while other portions of the display layer are having a high contrast due to working in combination with areas of the modifiable layer being switched to opaque.

Such areas can preferably be provided by parts of these areas having a higher resistance. If a certain area of a modifiable layer should change its degree of transparency, the voltage applied drops on the parts of said areas with a higher resistance and therefore the voltage could not activated the next area. In general, the voltage can be exemplarily applied at the borders of the modifiable layer for each of the areas independently. For providing such parts of higher resistance of said areas, e.g., the modifiable layer can be cut into independent peaces and assemble again afterwards, in particular by gluing.

Moreover, in a further embodiment of the invention the display devices can comprise at least two protective layers, at least two display layer, at least two modifiable layers, at least two insulating layers and/or at least two light emitting layers, whereby in particular between the at least two protective layers, the at least two display layer, the at least two modifiable layers, the at least two insulating layers and/or the at least two light emitting layers at least one of the other layers of the display device can be arranged.

With the help of at least two of said layers several embodiments are possible. For example, it is possible to arrange a first modifiable layer of each side of the display layer to provide only a portion of the display layer to be shown to a user while the contrast of the portion of the display layer shown is high due to the further modifiable layer switched to opaque at the back of the transparent display layer. Of course, several other advantageous embodiments using more than one of one or all of the layers can be used to generate different visual effects for a user.

Moreover, in a further embodiment of the invention the display device can comprise a frame wherein the at least one display device is held by said frame.

The problem of the present invention is also solved by a door or cover plate, in particular for a cooler, comprising at least one display device according to the invention.

In one preferred embodiment of the invention, at least on of the display device according to the invention can beneficially integrated into a door or cover plate.

In another preferred embodiment of the invention the door or cover plate comprises at least one media device configured and adapted to provide videos, pictures and/or technical information, preferably a temperature, to be displayed on the display device.

This is of advantage due to the fact that only a power supply has to be provided for the door or cover plate, while other technical device for displaying pictures, text, movies, or the like can already be integrated into the door directly.

Moreover, in a further embodiment of the invention the door or cover plate comprises at least one lighting unit, in particular a lighting unit comprising at least one light distribution unit, preferably the lighting unit is configured and adapted to be dimmable.

In another preferred embodiment of the invention the door or cover plate comprises at least one illumination device, in particular a LED-illumination, preferably configured and adapted to lighten the display layer, the modifiable layer, the protective layer, the insulating layer, and/or the light emitting layer, preferably comprising a LED-rail, wherein in particular the at least one illumination devices is arranged at the rim of at least one of the light emitting layers and/or the at least one illumination device is located adjacent to, in particular in direct contact with at least one protective layer and/or insulation layer.

Additionally, it can be advantageous that the door or cover plate comprises an illumination device, in particular a LED-illumination, preferably configured and adapted to lighten the transparent display layer and/or the modifiable layer.

With the help of such a lighting unit additional illumination of the door or cover plate can be realized as e.g. a back lighting of the transparent display layer or the modifiable layer. A LED-illumination can be beneficial due to the low energy consumption.

Moreover, in a further embodiment of the invention the door or cover plate comprises at least one door frame, preferably comprising or consisting of metal, in particular bordering the display device, wherein at least one door seal, at least one illumination device, at least one media device, at least one computer, and/or at least one power supply is arranged within the frame.

Such a metal frame can provide the space needed for placing the electric devices, mounting parts, door seals, and other, in particular, non transparent devices that are of advantage for a door or cover plate in several areas of application.

Moreover, in a further embodiment of the invention at least one LED-rail, OLED-rail and/or illuminant of the lighting unit and/or the illumination device is arranged within and/or held by the door frame, configured and adapted to light, at least in part, the light emitting layer (33), the protective layer and/or the insulating layer and/or a cooler, whereby preferably the at least one LED-rail, OLED-rail and/or illuminant of the lighting unit and/or the illumination device is arranged, in particular at least partly, on at least one side, preferably on at least two sides, of the rim of the door or cover plate.

Additionally, it can be advantageous that at least one LED-rail, OLED-rail and/or illuminant of the lighting unit and/or the illumination device is adapted and configured to irradiate light at the rim of the light emitting layer, the protective layer, the display layer, and/or the insulating layer and/or at least one LED-rail, OLED-rail and/or illuminant of the lighting unit and/or the illumination device is adapted and configured to irradiate light into a cooler, in particular if the door or cover plate is in a closing position.

Furthermore, the invention provides a cooler, comprising a display device according to invention and/or comprising a door or cover plate according to the invention.

A cooler with such a door or cover plate or such a display device according to the invention allows different modes of operation to allow a customer to see the products within the cooler, provide additional information on the transparent screen, and/or to prohibit a customer to have a direct look within the inner space of the cooler.

Finally, the invention provides a cooler, comprising at least one modifiable layer configured and adapted to change its degree of transparency, the modifiable layer is configured and adapted to change its degree of transparency depending on an input signal applied, preferably a voltage applied, in particular the modifiable layer is configured and adapted to switch between being transparent, semi-transparent, opaque and/or white, preferably depending on the input signal applied, wherein preferably the modifiable layer comprises or consist of a layered system comprising long-chain molecules, in particular polymer chains and/or molecules having a longer backbone and/or side chain, preferably the modifiable layer comprises or consist of polycarbonate resins and/or a transparent resin film, in particular an epoxy resin film and/or an acrylic resin film, and in particular comprising a display device according to invention and/or comprising a door or cover plate according to the invention

Such a cooler allows to decide, as desired, to allow a user to have see the inner space of a cooler or not. This might be useful depending one the products available for purchase, and/or e.g. depending on the installation side of the cooler for optical or marketing reasons.

Furthermore, according to one embodiment of the invention, at least one media device and/or at least one power supply for the display device is arranged at the back side of at least one of the coolers according to the invention.

The surprisingly technical effect of the present invention is that the contrast of a transparent display layer of a display device can be significantly raised by combining the transparent display layer with a modifiable layer that is configured and adapted to change its degree of transparency, whereby the modifiable layer is placed at least partly in front or behind the display layer.

Transparent display layers are known in the state of the art, but the contrast of such transparent display layers is restricted to the back grounds of the installation sides always. Depending on the installation side of such a transparent display layer, the contrast can be very weak. This may result in displaying elements on the transparent display layer with such a weak contrast that they are hardly recognizable for an observer. By using a combination of such a transparent display layer and a modifiable layer according to the invention, it is possible to improve the contrast of the display elements if desired. As a result, the displaying of elements on transparent display units become independent of the background. Furthermore, different modes of operations can be provided.

A display device according to the invention allows at least for different modes of operation. In a first mode of operation, the display device acts like a normal window or transparent glass. In the second mode of operation, elements can be shown on the transparent display layer. In a third mode of operation, the modifiable layer can change its degree of transparency to up to prohibiting a user to look through the display device. In a fourth mode of operation, the contrast of the transparent display layer can be raised by reducing the degree of transparency of the modifiable layer, until a desired contrast is achieved. Moreover, it might be possible to provide a light emitting layer to strength or weak the contrast of the display layer if desired. By using a dimmable light emitting layer further light effects can be realized.

It can thereby be possible to separate the modifiable layer into different areas configured and adapted to be able to work independent of each other. Furthermore, it can be advantageously to use more than one of each of the layers of the display device. For example, by using one modifiable layer at each side of the display layer it is possible to allow parts of the display layer to having a higher contrast by switching the modifiable layer partly to opaque while at the same time some parts of the display layer are hidden for a user by the modifiable layer arranged in front of the display layer.

By using such a display device according to the invention within a door or cover plate, it is possible to provide a multifunctional door. In particular, by using a door or cover plate comprising a display device according to the invention for a cooler, the cooler can be used as a conventional cooler with a transparent door, or additional information can be provided on the door of such a cooler for a customer.

It is for example possible to show advertising for products within the cooler while the modifiable layer is transparent or switched to opaque. In the first case, the products within the cooler are visible for the customer in addition to the displayed elements on the display device. In the second case, only the displayed elements on the display device are visible, while the opaque modifiable layer prevents the products within the cooler to be visible for the costumer.

Preferably, it can be possible using a display device according to the invention to provide also parts of the display device to be opaque, while other parts of the display device remain transparent.

In the alternative, it is also beneficial to use such a modifiable layer within a door or cover plate of a cooler without a transparent display layer. This allows to decide if the products within such a cooler are visible or not for a customer in case depending on various circumstances.

In the following description, the present invention is explained in more detail by means of a preferred embodiment relating to the enclosed drawings, wherein the figures show:

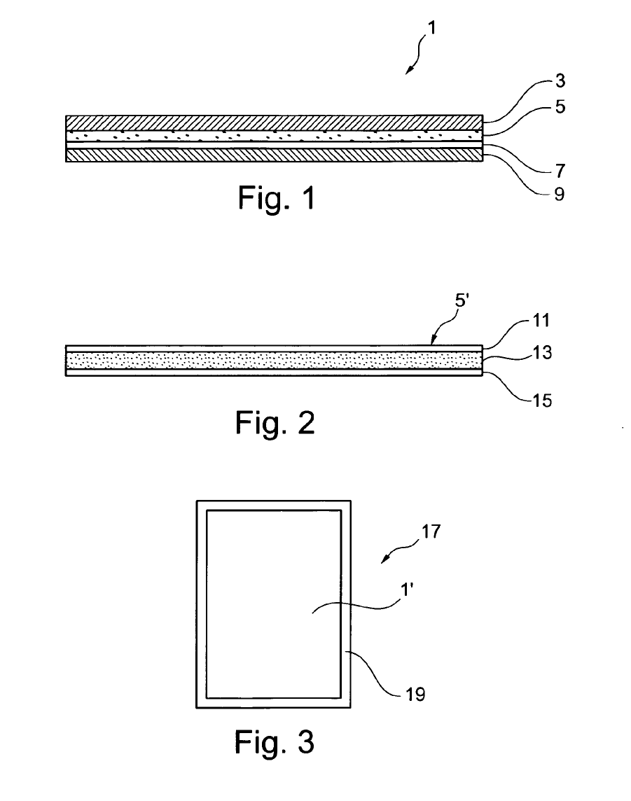

FIG. 1: a schematic side view of an embodiment transparent display according to the invention;

FIG. 2: a schematic side view of a film and/or foil providing a changing degree of transparency according to the invention;

FIG. 3: a schematic side view of a door or cover plate comprising a transparent display device according to the invention;

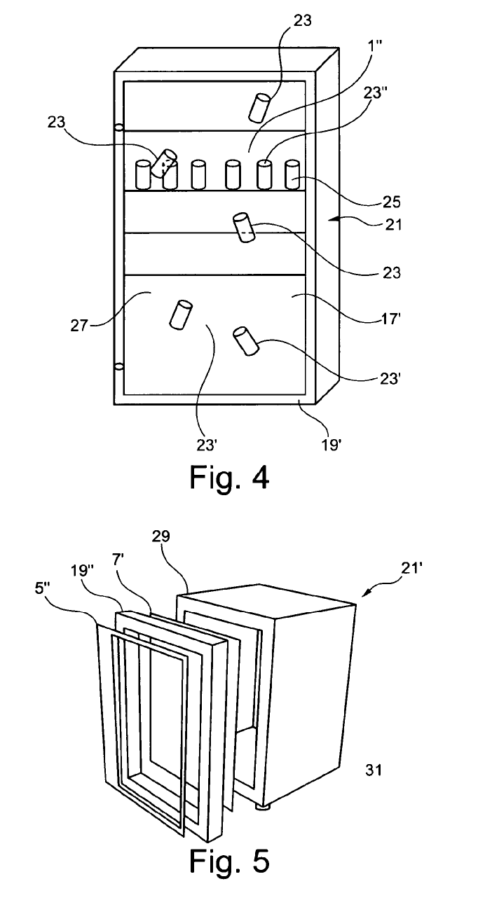

FIG. 4: a schematic view of a cooler according to the invention;

FIG. 5: a schematic perspective view of a cooler according to the invention;

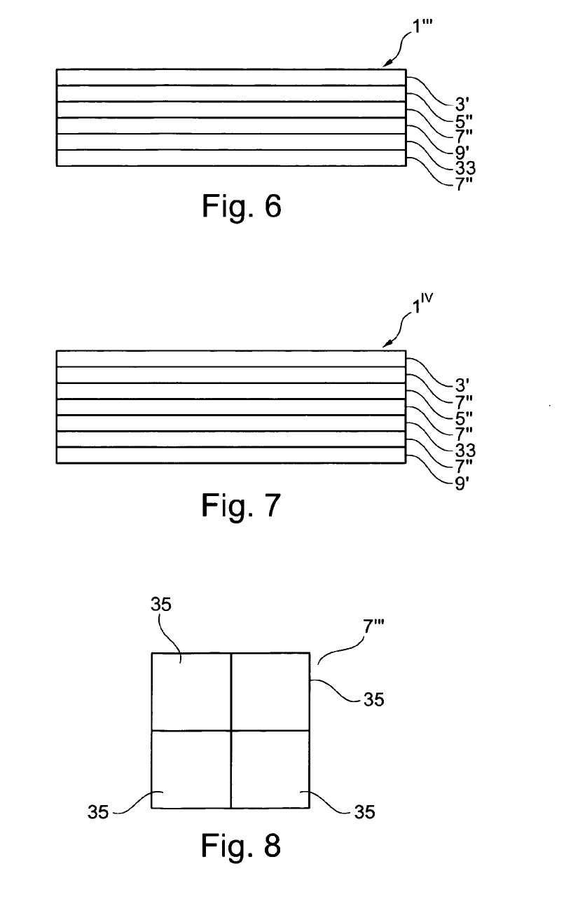

FIG. 6: a schematic side view of a further embodiment of a transparent display according to the invention;

FIG. 7: a schematic side view of a further embodiment of a transparent display according to the invention;

FIG. 8: a schematic top view of an embodiment of a modifiable layer according to the invention;

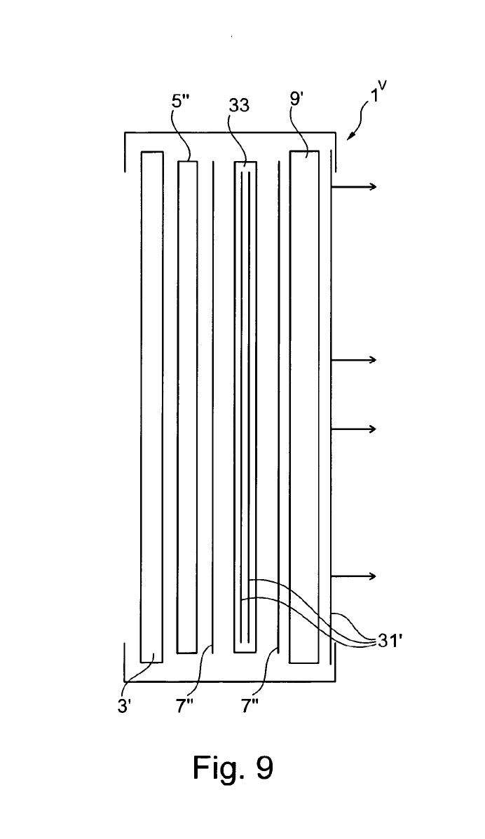

FIG. 9: a schematic side view of a further embodiment of a transparent display according to the invention;

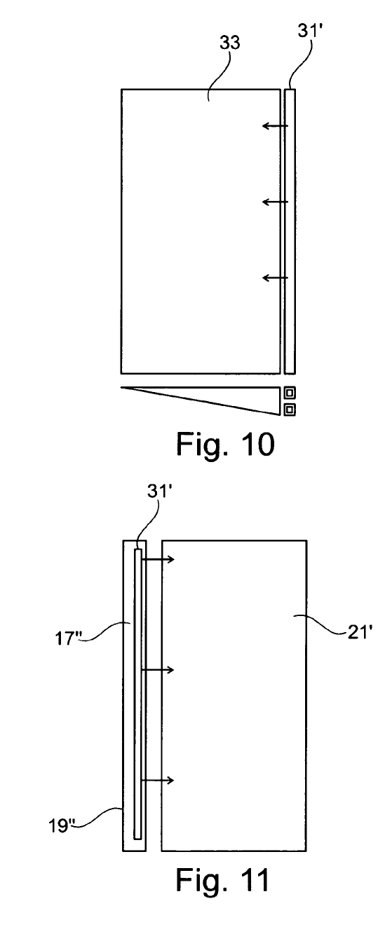

FIG. 10: a schematic side view of an embodiment of a light emitting layer comprising a LED-Rail according to the invention; and

FIG. 11: a schematic side view of a further embodiment of a light emitting layer and a cooler door comprising a LED-Rail according to the invention.

FIG. 1 shows a preferred embodiment of a display device 1 according to the invention. It is obvious for a person skilled in the art that the embodiment shown in FIG. 1 is only one possible example and that there are many other build-ups of display devices according to the invention possible.

The display device 1 of FIG. 1 comprises a protective layer 3 for protecting a transparent display layer 5. Preferably, the protective layer 3 is transparent, as shown in FIG. 1. In particular, it can be of advantage if the protective layer comprises or consists of glass. The transparent layer beneficial comprises or consist of at least one transparent Thin-FilmTransistor-display unit and/or layer and/or at least one transparent Organic-Light-EmittingDiode-display unit and/or layer.

Furthermore, a modifiable layer 7 is arranged on the opposite side of the transparent display layer 5 than the protective layer 3.

At the opposite side of the modifiable layer 7 than the transparent display layer 5 an insulating layer 9 is placed.

As a result, the layers of the display device 1 are lying upon another with a protective layer 3 being the first layer, the transparent display layer 5 being the second layer, the modifiable layer 7 being the third layer and the insulating layer 9 being the fourth layer.

This preferred embodiment provides the advantage that the contrast of the transparent display layer 5 can be optimized by adapting the degree of transparency of the modifiable layer 7.

FIG. 2 shows the build-up of a preferred embodiment of a modifiable layer 5′ according to the invention. Of course, several other build-ups of such modifiable layers are known to be possible for one skilled in the art.

The exemplary build-up of a modifiable layer 5′ comprises a first layer 11 comprising or consisting of indium tin oxide, a second layer 13 comprising or consisting of a transparency changing layer, preferably comprising or consisting of a polymer and/or liquid crystals, and a third layer 15 comprising or consisting of indium tin oxide, wherein the second layer 13 is arranged between the first and the third layer 11, 15.

The indium tin oxide layers 11, 15 provide a possibility to realize the transparent electrodes needed for the modifiable layer 5′ to be transparent and to apply an electric field to change the degree of transparency of the second layer 13.

FIG. 3 shows a schematic side view of a door or cover plate 17 comprising a transparent display device 1′ according to the invention.

The door or cover plate 17 has a frame 19. In particular, the door or cover plate 17 comprises at least one media device configured and adapted to provide videos, pictures and/or technical information, preferably a temperature, to be displayed on the display device 1′ (not shown). Furthermore, the frame 19 borders the display device 1′, wherein at least one door seal, at least one illumination device, at least one media device, at least one computer, and/or at least one power supply is preferably arranged within the metal frame 19 (not shown).

FIG. 4 shows a schematic view of a cooler 21 according to the invention. The cooler 21 comprises at lest on door 17′ having a frame 19′. In this preferred embodiment, the door 17′ of the cooler 21 comprises a display device 1″ according to the invention.

FIG. 4 shows exemplarily transparent cans 23 displayed on the display device 1″ for advertising. These cans are shown in addition to cans 25 placed inside the cooler 21. A different mode of operation is shown in a lower area 27 of the cooler 21. In this lower area 27 the modifiable layer (not shown) is switched to opaque, so that the cans within the cooler are not visible for a customer. Instead, the cans 23′ displayed on the display layer have a higher contrast than the cans 23.

FIG. 5 shows a schematic perspective view of a cooler 21′ according to the invention. The cooler 21′ comprises a housing 29, a modifiable layer 7′, a frame 19″ and a display layer 5″. Furthermore, a LED-rail 31 is arranged close to the frame 19″.

Preferably, the display layer 5″ provides a resolution of 1680×1050 pixel. Furthermore, in this preferred embodiment of the invention, the switching time from transparent to opaque of the modifiable layer 7′ is 10 ms at the maximum.

With the help of the LED-rail 31 the display layer 5″ and/or the modifiable layer 7′ can be illuminated in addition. It is thereby preferred to use while LED-rails 31 that are in particular located within the frame 19′.

FIG. 6 shows another preferred embodiment of a display 1″′ according to the invention. The display 1″′ comprises the following layers lying upon each other with a protective layer 3′ being the first layer, a display layer 5″ being the second layer, a modifiable layer 7″ being the third layer, an insulating layer 9′ being the fourth layer, a light emitting layer 33 being the fifth layer, and another modifiable layer 7′″ being the sixth layer.

FIG. 7 shows another preferred embodiment of a display 1^{IV} according to the invention. The display 1^{IV} comprises the following layers lying upon each other with a protective layer 3′ being the first layer, a modifiable layer 7″ being the second layer, a display layer 5″ being the third layer, another modifiable layer 7″ being the fourth layer a light emitting layer 33 being the fifth layer, another modifiable layer 7″ being the sixth layer, and an insulating layer 9′ being the seventh layer.

FIG. 8 shows a schematic top view of an embodiment of a modifiable layer 7′″ according to the invention. The modifiable layer 7′″ is exemplarily divided into 4 different areas 35. Such areas 35 can preferably be provided by parts of the areas having a higher resistance. If a certain area of a modifiable layer should change its degree of transparency, the voltage applied drops on the parts of the areas having a higher resistance and therefore the voltage could not activated the next area. In the embodiment shown in FIG. 8, each of the areas 35 can change its degree of transparency independent of each other. This is due to the fact that the control voltage for changing the degree of transparency of the areas 35 can be applied at the boarders of the modifiable layer 7′″ for each of the areas 35 separately.

FIG. 9 shows another preferred embodiment of a display 1^{V} according to the invention. The display 1^{V} comprises the following layers lying upon each other with a protective layer 3′ being the first layer, a display layer 5″ being the second layer, a modifiable layer 7″ being the third layer, a light emitting layer 33 being the fourth layer, another modifiable layer 7″ being the fifth layer, and an insulating layer 9′ being the sixth layer. As an alternative, the insulating layer 9′ can be replaced by another protective layer (not shown). Two LED-rails 31′ are arranged exemplarily at the rim of the light emitting layer 33, irradiating light into the light emitting layer 33. Another LED-rail 31′ is located adjacent to, in particular in direct contact with the insulating layer 9′or in the alternative to the not shown further protective layer replacing the insulating layer 9′.

FIG. 10 shows a schematic side view of an embodiment of a light emitting layer 33 comprising a LED-rail 31′ according to the invention. Thereby the LED-rail 31′ is arranged exemplarily on one side of the rim of the light emitting layer 33 irradiating light into the light emitting layer 33 configured and adapted to work as a light diffuser. It is obvious for a person skilled in the art that the LED-rail 31′ can also be arranged at other parts of the rim of the light emitting layer 33, or arranged only at parts of a rim of the light emitting layer 33.

FIG. 11 shows a schematic side view of a further embodiment of a light emitting layer and a cooler door 17″ comprising a LED-Rail 31′ according to the invention. Thereby, a LED-rail 31′ is arranged at a frame 19″ of a door 17″ , in particular close to the rim of the frame 19″, in a way to emit light into the direction of a cooler 21′, in particular if the door 17″ is in a closing position.

The features of the present invention disclosed in the description above, in the claims and in the drawings can be used for implementing the invention in its different embodiments both individually and in every possible combination thereof.

### REFERENCE LIST

1, 1′, 1″, 1″′, 1^{IV}, 1^{V} display device

3, 3′ protective layer

5, 5′, 5″ display layer

7, 7′, 7″, 7′″ modifiable layer

9, 9′ insulating layer

11, 15 indium tin oxide layer

13 transparency changing layer

17, 17′, 17″ door

19, 19′, 19″ frame

21, 21′ cooler

23, 23′ transparent can

25 can

27 area

29 housing

31 LED-rail

33 light emitting layer

35 area

1. A display device comprising at least one transparent or translucent display layer, and at least one modifiable layer comprised of a film or foil layer, configured and adapted to have a degree of transparency modified depending on an input signal applied thereto and placed at least partly in front and/or behind said display layer.

2. The display device according to claim 1, wherein the modifiable layer is configured and adapted to modify its degree of transparency depending on a voltage applied thereto.

3. The display device according to claim 1, wherein the modifiable layer is configured and adapted to switch reversibly between being transparent, semi-transparent, opaque, and/or white depending on an input signal applied thereto.

4. The display device according to claim 1, wherein the modifiable layer is located adjacent to the display layer.

5. The display device according to claim 1, wherein the modifiable layer is laminated at least on parts of a glass support and/or parts of the display layer.

6. The display device according to claim 1, wherein the at least one modifiable layer comprises, in particular in this sequence, a first layer comprising indium tin oxide, a second layer comprising a transparency changing layer comprising a polymer and/or liquid crystals, and a third layer comprising indium tin oxide.

7. The display device according to claim 6, wherein the second layer is arranged, at least partly, between the first layer and the third layer.

8. The display device according to claim 1, wherein the display layer comprises at least one transparent Thin-Film-Transistor-(TFT)-display unit and/or layer and/or at least one transparent Organic-Light-Emitting-Diode-(OLED)-display unit and/or layer.

9. The display device according to claim 1, further comprising at least one protective layer and/or at least one insulating layer.

10. The display device according to claim 9, further comprising at least one light emitting layer configured and adapted to emit light, wherein the at least one light emitting layer comprises light emitting diodes, organic light emitting diodes, and/or cold-cathode fluorescent lamps, the light emitting layer being configured and adapted to be dimmable and/or transparent and/or the light emitting layer having a structure configured and adapted to diffuse light irradiated in at least one of the edges of the light emitting layer to emit light irradiated in at least one of the edges of the light emitting layer toward at least one of the other layers.

11. The display device according to claim 10, wherein the at least one light emitting layer and/or the display device further comprises stripes of light emitting diodes, organic light emitting diodes, and/or cold-cathode fluorescent lamps, along a rim of the protective layer and/or the insulating layer.

12. The display device according to claim 10, wherein the at least one modifiable layer and/or the at least one light emitting layer is coated and/or evaporated onto at least one of the layers of the display device onto the at least one display layer, the at least one protective layer, and/or the at least one insulating layer.

13. The display device according to claim 9, wherein the display layer is, at least partly, arranged between at least a first protective layer and at least a second protective layer, between at least one protective layer and at least one insulating layer, and/or between at least a first insulating layer and at least a second insulating layer.

14. The display device according to claim 10, wherein the protective layer, the light emitting layer, and/or the insulating layer are, at least partly, transparent.

15. The display device according to claim 9, wherein the protective layer and/or the insulating layer comprises glass.

16. The display device according to claim 1, in which the individual layers of the display device are arranged in the following sequence: a protective layer being a first layer, the display layer being a second layer, the modifiable layer being a third layer, and an insulating layer or another protective layer being a fourth layer, and at least one light emitting layer is arranged between the first, second, third, and/or fourth layer, or the at least one light emitting layer is a fifth layer being arranged in front of the first layer or at the back of the fourth layer.

17. The display device according to claim 1, in which the individual layers of the display device are arranged in the following sequence: a protective layer being a first layer, the display layer being a second layer, an insulating layer or another protective layer being a third layer, the modifiable layer being a fourth layer, the light emitting layer being a fifth layer, and another insulating layer, protective layer, and/or modifiable layer being a sixth layer.

18. The display device according to claim 1, wherein a light emitting layer is arranged between a first modifiable layer and a second modifiable layer.

19. The display device according to claim 1, wherein the modifiable layer comprises at least n areas, n being a whole number greater than or equal to 2, wherein each of the at least two areas of the modifiable layer are configured and adapted to change their degree of transparency independently depending on an input signal applied thereto.

20. The display device according to claim 19, wherein the areas of the modifiable layer are separated by borders of the areas having a higher resistance.

21. The display device according to claim 1, further comprising at least two protective layers, at least two display layers, at least two modifiable layers, at least two insulating layers, and/or at least two light emitting layers, wherein between the at least two protective layers, the at least two display layers, the at least two modifiable layers, the at least two insulating layers, and/or the at least two light emitting layers at least one of the other layers of the display device is arranged.

22. The display device according to claim 1, further comprising a frame, wherein the display device is held by said frame.

23. A door or cover plate for a cooler, comprising at least one display device according to claim 1.

24. The door or cover plate according to claim 23, further comprising at least one media device configured and adapted to provide videos, pictures, and/or technical information for display on the display device.

25. The door or cover plate according to claim 23, wherein the door or cover plate comprises at least one lighting unit comprising at least one dimmable light distribution unit.

26. The door or cover plate according to claim 23, further comprising at least one illumination device configured and adapted to illuminate the display layer, the modifiable layer, the protective layer, the insulating layer, and/or a light emitting layer, wherein the at least one illumination device is arranged at a rim of at least one light emitting layer and/or the at least one illumination device is located in direct contact with at least one protective layer and/or insulation layer.

27. The door or cover plate according to claim 23, further comprising at least one door frame bordering the display device, wherein at least one door seal, at least one lighting unit, at least one illumination device, at least one media device, at least one computer, and/or at least one power supply is arranged within and/or held by the at least one door frame.

28. The door or cover plate according to claim 27, further comprising at least one LED-rail, OLED-rail, and/or illuminant of the at least one lighting unit and/or the illumination device arranged within and/or held by the door frame, configured and adapted to light, at least in part, the light emitting layer, the protective layer and/or the insulating layer, and/or a cooler (21, 21′), whereby preferably wherein the at least one LED-rail, OLED-rail, and/or illuminant of the at least one lighting unit and/or the illumination device is arranged, at least partly, on at least one side of a rim of the door or cover plate.

29. The door or cover plate according to claim 28, wherein the at least one LED-rail, OLED-rail, and/or illuminant of the at least one lighting unit and/or the illumination device is adapted and configured to irradiate light at a rim of the light emitting layer, the protective layer, the display layer , and/or the insulating layer, and/or the at least one LED-rail, OLED-rail, and/or illuminant of the at least one lighting unit and/or the illumination device is adapted and configured to irradiate light into a cooler when the door or cover plate for the cooler is in a closing position.

30. A cooler comprising a display device according to claim 1.

31. The cooler of claim 30, wherein depending on the input signal applied, the modifiable layer is configured and adapted to change its degree of transparency and switch between being transparent, semi-transparent, opaque, and/or white, wherein the modifiable layer comprises or consists of a layered system comprising long-chain molecules including polymer chains and/or molecules having a longer backbone and/or side chain.

32. The cooler according to claim 30 , wherein at least one media device and/or at least one power supply for the display device is arranged at a back side and/or the door frame of the cooler.

33. The display device according to claim 2, wherein the modifiable layer is or comprises an electrochromic layer.

34. The display device according to claim 4, wherein the modifiable layer is located in direct contact with the display layer.

35. The display device according to claim 11, wherein the stripes of light emitting diodes, organic light emitting diodes, and/or cold-cathode fluorescent lamps are applied to the front and/or the back surface of the protective layer and/or the insulating layer.

36. The display device according to claim 16, wherein at least two adjacent layers are contacting each other.

37. The display device according to claim 17, wherein at least two adjacent layers are contacting each other.

38. The door or cover plate according to claim 27, wherein the at least one door frame is comprised of metal.

39. A cooler comprising a door or cover plate according to claim 23.

40. The cooler of claim 31, wherein the modifiable layer comprises a polycarbonate resin and/or a transparent resin film, wherein the transparent resin film is an epoxy resin film and/or an acrylic resin film.
